(19) United States
(12) Patent Application Publication
(10) Pub. No.: US 2023/0368220 A1
(43) Pub. Date: Nov. 16, 2023

(54) APPLICATION COMPILING AND EVALUATING CONSUMER CHOICES AND PROVIDING RECOMMENDATIONS BASED ON USER COMMONALITIES

(71) Applicant: Cliqrex Inc., Cincinnati, OH (US)

(72) Inventors: James O’Loughlin, Cincinnati, OH (US); Dara O’Loughlin, Cincinnati, OH (US)

(73) Assignee: Cliqrex Inc., Cincinnati, OH (US)

(21) Appl. No.: 18/318,500

(22) Filed: May 16, 2023

Related U.S. Application Data
(60) Provisional application No. 63/342,491, filed on May 16, 2022.

(51) Int. Cl. G06Q 30/0201; G06Q 30/0282; G06Q 30/0601

(52) U.S. Cl. CPC G06Q 30/0201; G06Q 30/0282; G06Q 30/0631

(57) ABSTRACT

Recommendations for consumer choices based on affinities the user has with others by assessing commonalities with other users to provide more trustworthy recommendations to the user. Similarity of tastes between individuals are compared by noting favorability ratings, sentiments, and consumption patterns to indicate recommendations based on such comparisons.

### CROSS-REFERENCE TO RELATED APPLICATION

This application claims the benefit of U.S. Provisional Application Serial No. 63/342,491 filed May 16, 2022. The disclosures, drawings and descriptions thereof are incorporated herein by this reference.

### FIELD OF THE INVENTION

The present invention relates to a downloadable software application to assist consumer choices in a complex environment having an extraordinary array of choices by compiling and evaluating individual consumer choices and organizing choices made by users based on common user choices to display to a consumer information based on choices made by similar users of the application.

### BACKGROUND OF THE INVENTION

Consumer choices, particularly in digital media, are exploding with currently more than 300 streaming services available to consumers, and it is estimated 80% of the U.S. population uses one or more of such streaming services as Netflix, Hulu and the like, offering tens of thousands of viewing choices to consumers. Other areas of consumer engagement, such as restaurants, service providers, parks and recreation areas, podcasts, theaters, among a host or others result in social media and promotional exposures that can be overwhelming. Most search engines are based solely on AI and impacted by advertisers and influencers. Recommendations from trusted associates, family and friends cannot easily be relied upon considering the seemingly overwhelming array of choices available to consumers, and the proliferation of advertisers and influencers on digital media.

And, increasingly, consumers are becoming every more wary of traditional social media due to its effects on mental health and the often the misinformation and “echo chambers” that result from traditional digital media promoting choices for consumers.

### SUMMARY OF THE PRESENT INVENTION

To assist such consumers, the present invention creates recommendations for consumer choices based on affinities the user has with others by assessing common choices with other users to provide more trustworthy recommendations to the user. The present invention compares similarity of tastes between individuals by comparing favorability ratings, sentiments, and consumption patterns across a broad range of products and services, and can include television shows, movies, podcasts, books, YouTube channels, and any other product or service providing a multitude of consumer choices.

This information of recommendations based on affinities with other users, collected, evaluated and compared through a downloadable software application or “app,” or website, can be displayed visually to the user, and in one embodiment of the present invention, varying degrees of colored rings are provided around a user’s profile or photo with the completion or visual intensity of the rings providing an easily understandable display of recommendations to the user.

Users can tell if they have similar tastes to other persons having made choices simply by glancing at the visual ring or rings to determine the affinity with the other users based on prior selections. This visual display becomes a quick indicator to the user of the extent the user can trust the recommendation to be something resulting from choices made by users having common affinities, and not recommendations resulting solely from AI, advertisers or other influencers.

These and other objects, features and advantages of the present invention will become apparent from the following descriptions of preferred embodiments.

### BRIEF DESCRIPTIONS OF THE DRAWINGS

FIG. 1 illustrates the basic operation of the present invention;

FIG. 2 illustrates the infrastructure;

FIG. 3 illustrates the display data inputs;

FIG. 4 illustrates the manner of calculating affinities;

FIG. 5 illustrates the steps to display affinities to the user;

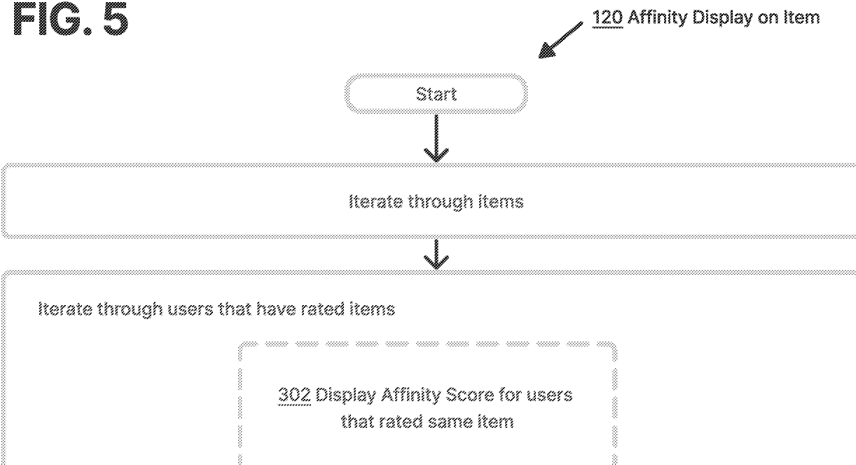

FIG. 6 illustrates the display to the user.

### DETAILED DESCRIPTION OF PREFERRED EMBODIMENT

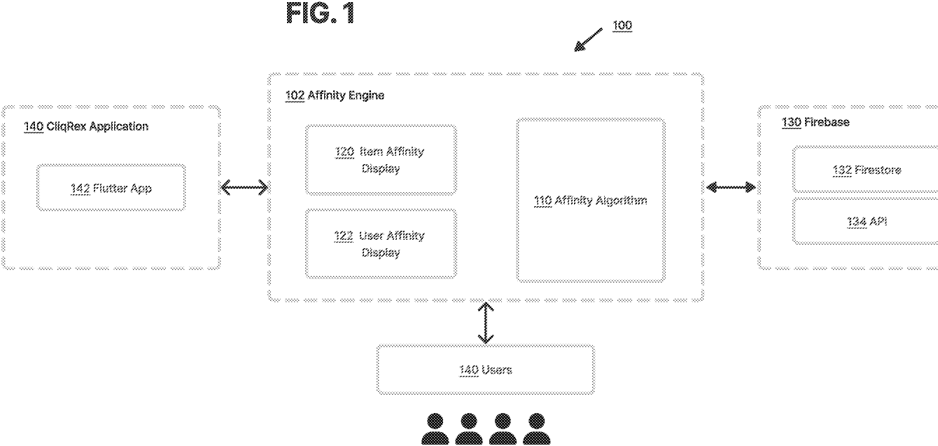

FIG. 1 illustrates the basic operation of the present invention, and the application 100 includes an affinity engine 102 that calculates scores based on user input regarding the various user’s 140 reaction to a particular consumer choice, identified as 204 items. Common characteristics of users 140 are recorded and stored online with Firebase 130 and compared in Affinity Algorithm 110 to an inquiring user’s choices to produce an affinity result in order to display to the inquiring user the degree of alignment with other user’s and their reaction to the consumer choice.

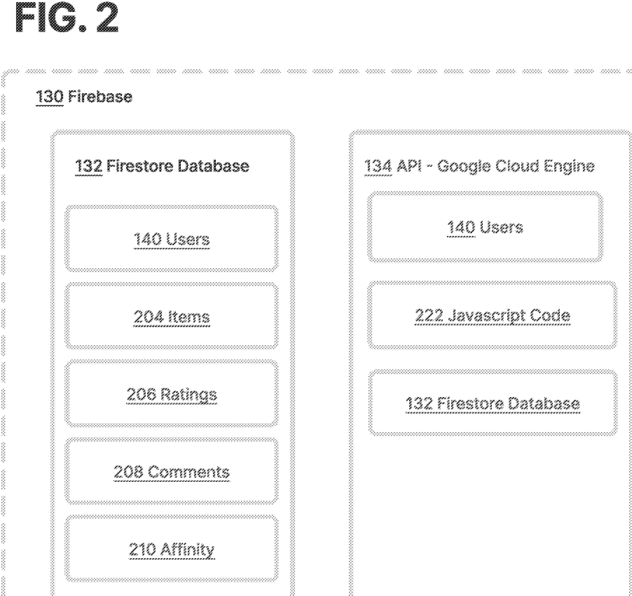

The Firebase 130 of FIG. 2 stores the user’s 140 personal information entered by the user and privacy settings, and the items 204 reviewed by the various users, including their ratings 206 and comments 208 as well as commonalities or Affinity 210 established among users. The Firestore data storage 132 performs the required data relay functions and data comparisons of received ratings 206 and comments 208 and determines affinity across multiple users. These functions and analysis are triggered via Javascript Code 222 interactions against the Firestore Database 132, and the Users 140 can store their personal information and privacy settings within the Firestore Database 132.

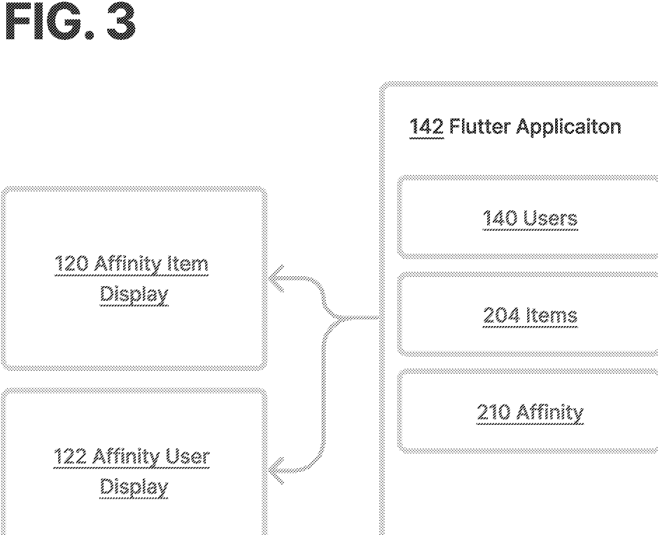

The comparisons of user interactions and affinities among the various users for a particular consumer choice are recorded and analyzed to drive the display as set forth in FIG. 3 to indicate the user’s alignment to the items 204 among the users 140. To enhance user engagement and understanding, the display is preferably a ring around the user’s photograph or profile, and the transparency of the ring is a visual representation of the affinity data analysis. For example, if two users have reviewed and rated or commented upon ten or more of the same consumer choices, such as ten or more Netflix movies, the ring would be fully opaque indicating a strong affiliation with another user. If nine consumer choices in common have been reviewed, the ring would be 90% transparent, if eight common choices, 80% transparency. The increasing transparency is proportional to the number of common consumer choices reviewed, and the transparent intensity of the ring indicates clearly and instantly to the user the degree of commonality and trust the user can have in the recommendation.

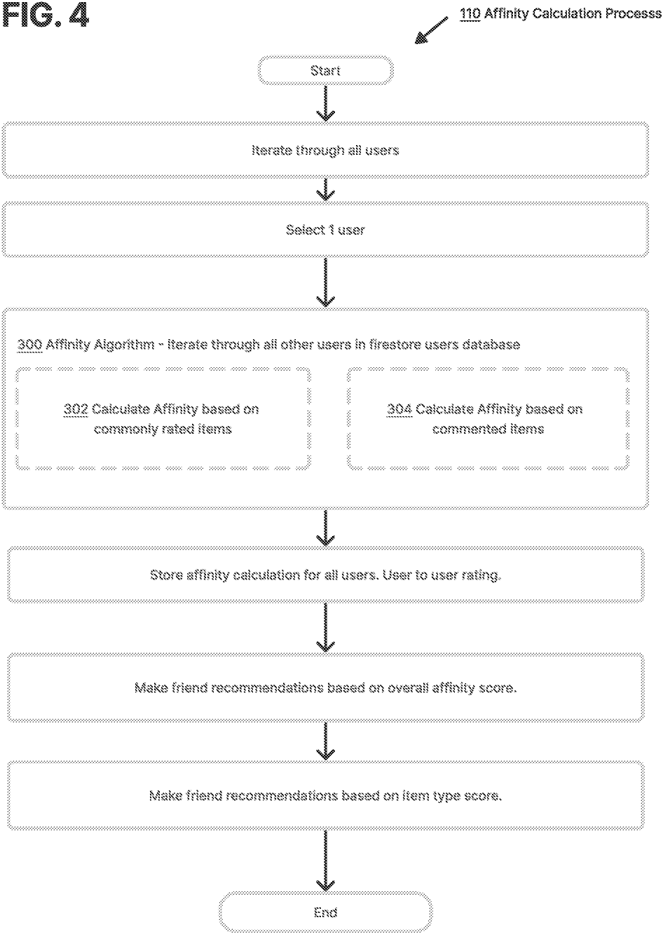

The ring as described also indicates an affinity score, to visualize the user’s match with another user. Each common consumer choice, such as a Netflix movie, is given an affinity score by the process illustrated in FIG. 4. The program selects a user based on commonly rated consumer items and provides a calculation starting as a base, and increases the base number proportionately to the number of ratings for the same consumer choice. In the event there has not been a judgment by each user on a particular consume choice, that particular item is not used in the analysis. But whether negative or positive, or in agreement, such decisions are used inteh analysis. If there has been 100% agreement on ratings for the common consumer choices, the calculated Affinity is scored at its highest level, with proportionate decreases depending on the number of common consumer choices that the ratings have not agreed.

This Affinity score is displayed on the visual ring. The affinity algorithm 300 is calculated for users 140 based on items 140 and ratings and the visual ring displays the Affinity score by the extend the complete circle of the ring is completed. The more the circle of the ring is complete, the more the Affinity score and the more the taste of the comparing users are aligned. And as noted above, the transparency of the ring illustrates the data points analyzed to provide the results.

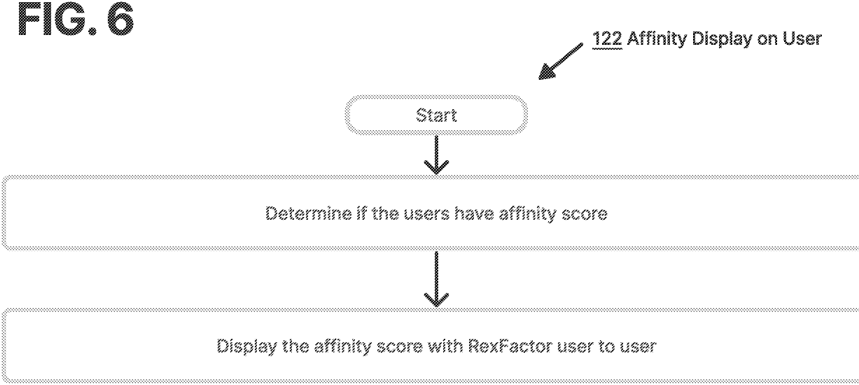

FIG. 6 illustrates this the display quickly and clearly communicates to the user the degree of affinity the user has with the comparison user, and the degree of commonality in taste to enable a quick and reliable judgment of whether the selected consumer choice is to be recommended to the user based on real time decisions and comments made by individuals with common interests, not advertisers and influencers.

What is claimed is:

1. A method of providing recommendations to a user of a consumer choice, including organizing a plurality of users having an interest in that consumer choice, and comparing comments made by such users of such consumer choice and visualizing the degree such comments should be considered as a recommendation for such consumer choice.

2. The method of claim 1, wherein such visualizing includes a ring having its degree of transparency indicative of the number of common consumer choices in comparing comments made by such users of such consumer choice.

3. The method of claim 2, wherein such ring is completed in uniform intensity depending on the degree of alignment of such comments.

4. The method of claim 1, wherein such visualizing includes a ring having completed in uniform intensity depending on the degree of alignment of such comments.

5. A software program to assist consumer choices in an environment having an array of choices to provide recommendations to a user of a consumer choice performing the method of claim 1.

6. A software program to assist consumer choices in an environment having an array of choices to provide recommendations to a user of a consumer choice by organizing a plurality of users having an interest in that consumer choice, and comparing comments made by such users of such consumer choice and visualizing the degree such comments should be considered in a recommendation for such consumer choice.

7. The software program of claim 6, such visualizing includes providing a ring having its degree of transparency indicative of the number of common consumer choices in comparing comments made by such users of such consumer choice.

8. The software program of claim 7, wherein such ring is completed in uniform intensity depending on the degree of alignment of such comments.

9. The software program of claim 6, wherein such visualizing includes a ring having completed in uniform intensity depending on the degree of alignment of such comments.
